(19) United States
(12) Patent Application Publication
(10) Pub. No.: US 2013/0162214 A1
(43) Pub. Date: Jun. 27, 2013

(54) CAPACITOR ACTIVE BALANCING DEVICE WITH HIGH-VOLTAGE DIFFERENTIAL AND METHOD THEREOF

(71) Applicants: Kuan Yuen LIAO, Kaohsiung City (TW); Sheng Wei Chen, Kaohsiung City (TW); Wen Jiun Liu, Kaohsiung City (TW)

(72) Inventors: Kuan Yuen LIAO, Kaohsiung City (TW); Sheng Wei Chen, Kaohsiung City (TW); Wen Jiun Liu, Kaohsiung City (TW)

(73) Assignee: Metal Industries Research & Development Centre, Kaohsiung City (TW)

(21) Appl. No.: 13/332,374

(22) Filed: Dec. 21, 2011

(51) Int. Cl. H02J 7/00

(52) U.S. Cl. 320/121

(57) ABSTRACT

A capacitor active balancing device with high-voltage differential and the method thereof are disclosed. A plurality of cells are connected in series for charging an energy storage unit under a high-voltage differential. The energy storage unit discharges cells of lower power to achieve battery balancing. The mechanism helps improve the efficiency of battery balancing.

### BACKGROUND OF THE RELATED ART

1. Technical Field

The invention relates to a capacitor active balancing device and the method thereof. In particular, the invention relates to a capacitor active balancing device with high-voltage differential that has at least two cells connected in series to charge an energy storage unit and utilizes the energy storage unit to transfer energy, as well as the method thereof.

2. Related Art

In recent years, the popularity and prosperous development of secondary battery (also known as rechargeable battery) bring wide applications in such vehicles as hybrid cars, fuel battery cars, electric cars, etc. However, batteries may degrade rapidly under various kinds of environments. It is therefore an imperative issue for vendors to increase the lifetime of batteries.

Generally speaking, a battery consists of several cells connected in series. Since each cell may have different material properties from the others, it is likely to have overcharge/overdischarge during charging/discharging processes, affecting the lifetime of the battery. To avoid this problem, the battery balancing technique is employed to moderate energy among the cells so that all of them reach their threshold voltage simultaneously during the charging process. Currently, the technique can be divided into active balancing and passive balancing. Due to its small energy loss and little heat generation, the active balancing receives a lot of attention. Commonly seen active balancing styles include capacitor balancing and inductor balancing. The former has a lighter weight and lower efficiency, whereas the latter has a heavier weight and higher efficiency. The inductor balancing has thus become the current mainstream. However, under the consideration of weight, the importance of capacitor balancing cannot be overlooked.

In the capacitor balancing technique, some vendor proposes to use programmable control logic to control an arbitrary pair of switches (i.e., the paired switches that connect the positive and negative poles of a cell) to balance the voltage between the capacitor and the cell. It can freely control the on/off time of the switches. Nevertheless, the above-mentioned method applies only to the battery balancing of a single cell and a capacitor. It cannot effectively solve the problem of low efficiency in battery balancing.

In summary, the prior art always has the problem of low efficiency in capacitor battery balancing. It is thus desirable to provide a solution.

### SUMMARY

In view of the foregoing, the invention discloses a capacitor active balancing device with high-voltage differential and the method thereof

The disclosed capacitor active balancing device with high-voltage differential includes: a plurality of cells, a switch control unit, and an energy storage unit. N cells are connected in series for storing and providing electrical power, where N is a positive integer no less than 2. The switch control unit electrically connects to the cell series for switching and forming a power supply series of K cells connected in series in a first state and for switching and forming a power charging series of L cells connected in series in a second state. Here K and L are positive integers and N≧K≧2, K−1≧L≧1. The energy storage unit electrically connects to the switch control unit for receiving and storing electrical power from the power supply series in the first state, and for outputting the electrical power of the energy storage unit to charge the power charging series in the second state.

The disclosed method of capacitor active balancing with high-voltage differential includes the steps of: providing N cells connected in series to form a cell series for storing and providing electrical power, where N is a positive integer no less than 2; when the switch control unit is in a first state, switching the electrical connection to the cell series to form a power supply series of K cells, where the power supply series output electrical power to the energy storage unit for storage and K is a positive integer and N≧K≧2; when the switch control unit is in a second state, switching the electrical connection to the cell series to form a power charging series of L cells, where the energy storage unit outputs electrical power to charge the power charging series and L is a positive integer and K−1≧L≧1.

As described above, the invention differs from the prior art in that the invention has several cells connected in series to charge the energy storage unit under high-voltage differential. The energy storage unit discharges cells of lower power to complete energy transfer and battery balancing.

Using the above-mentioned technique, the invention achieves the goal of increasing battery balancing efficiency.

### BRIEF DESCRIPTION OF THE DRAWINGS

The invention will become more fully understood from the detailed description given herein below illustration only, and thus is not limitative of the present invention, and wherein:

FIG. 1 is a system block diagram of the disclosed capacitor active balancing device with high-voltage differential;

FIG. 2 is a flowchart of the disclosed capacitor active balancing method with high-voltage differential;

FIG. 3 is a circuit diagram of the disclosed capacitor active balancing device with high-voltage differential;

FIG. 4 shows how to form the power supply series according to the invention;

FIG. 5 shows how to form the power charging series according to the invention;

FIG. 6 is a circuit diagram of the switch control unit in another embodiment of the invention; and

FIGS. 7A and 7B are schematic views that compare voltage and current curves of the invention and the conventional capacitor balancing.

### DETAILED DESCRIPTION

The present invention will be apparent from the following detailed description, which proceeds with reference to the accompanying drawings, wherein the same references relate to the same elements.

Before describing the disclosed capacitor active balancing device with high-voltage differential and the method thereof, we first explain terms used herein. The cell series refers to N cells connected in series, where N is a positive integer no less than 2, such as 2, 3, 4, etc. The power supply series refers to K cells connected in series for charging the energy storage unit. The power charging series refers to L cells connected in series for receiving and storing electrical power from the energy storage unit. Here K and L are positive integers, with N≧K≧2 and K−1≧L≧1.

Suppose N=3, then K=3 or 2 and L=2 or 1. Generally speaking, the electrical power in cells of the power supply series is higher on the average. However, it is not excluded that the power supply series may contain cells with electrical power lower than the average.

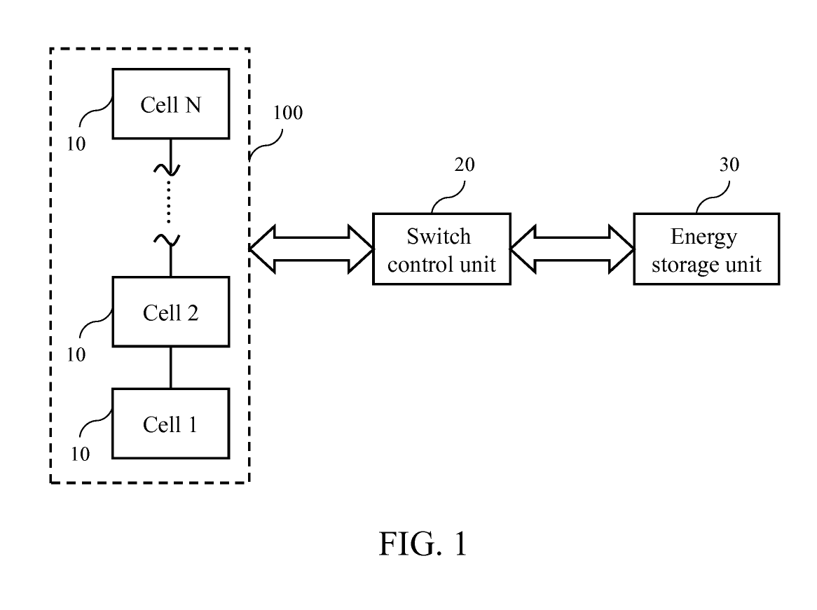

FIG. 1 is a system block diagram of the disclosed capacitor active balancing device with high-voltage differential. The system includes: cells 10, a switch control unit 20, and an energy storage unit 30. N cells 10 are connected in series into a cell series 100 for storing and supplying electrical power, where N is a positive integer no less than 2, such as 2, 3, 4, etc. The cell series 100 has been defined before and is not further described here.

The switch control unit 20 electrically connects to the cell series 100. It switches the electrical connection with the cell series 100 in a first state, thereby forming a power supply series of K cells (not shown). The first state is the state of transferring electrical energy from the cells 10 to the energy storage unit 30. When to transfer electrical energy is determined by the amount of electrical energy in each of the cells 10. In a second state, the switch control unit 20 switches the electrical connection to the cell series 100 to form a power charging series (not shown) of L cells 10. Here K and L are positive integers with N≧K≧2 and K−1≧L≧1. The second state is the state of transferring electrical energy from the energy storage unit 30 to the power charging series. For example, suppose N=4 and K=2. Then the number of cells 10 in the power charging series L=1 (that is, 2−1≧L≧1). Suppose N=4 and K=3, the number of cells 10 in the power charging series is 2 or 1. Whether the number of cells 10 is 2 or 1 is determined by the electrical power in the cells 10. To charge the cell 10 with the lowest electrical power, the number of cells in the power charging series is then 1. To charge all cells 10 with lower electrical power, the number of cells in the power charging series is then 2. In practice, the switch control unit 20 may consist of a microcontroller and several switches. Cells 10 with electrical power lower than the average may connect with other cells 10 in series to form the power supply series. Cells 10 with electrical power higher than the average may connect with other cells 10 in series to form the power charging series. The switch can be a metal-oxide-semiconductor field effect transistor (MOSFET). After the control selects the first or second state, the controller controls the on and off of the switch so that the cells 10 and the energy storage unit 30 form a suitable charging/discharging circuit. Generally speaking, the residual electrical power of each cell 10 may vary with time. Therefore, the switch control unit 20 alternates between the first and second state. The cells as the power supply series and power charging series and the number thereof also vary with time. The method of using the switch control unit 20 to form the power supply series and power charging series will be described in detail with reference to accompanying drawings later.

The energy storage unit 30 electrically connects to the switch control unit 20 for receiving and storing electrical power from the power supply series in the first state. That is, the power supply series formed by the switch control unit 20 in the first state has high-voltage differential with the energy storage unit 30. Therefore, the power supply series charges the energy storage unit 30. In the second state, the switch control unit 20 already finishes the switch and forms the power charging series. The electrical energy of the power charging series is lower. The energy storage unit 30 thus outputs electrical power to the power charging series for charging. This completes the procedure of using the energy storage unit 30 to move electrical energy of two or more cells 10 (i.e., power supply series) to cells 10 (i.e., power charging series) with lower electrical energy, thereby achieving active balancing. It should be mentioned that the energy storage unit 30 contains at least one capacitor for storing and providing electrical power. The capacitor may even connect in series to a resistor to form an RC circuit. The resistor can be a capacitor equivalent resistor, normal resistor, switch resistor, battery internal resistor or their combination. The resistance or capacitance of the circuit connected in series with the resistor and the capacitor can be adjusted to set a response time.

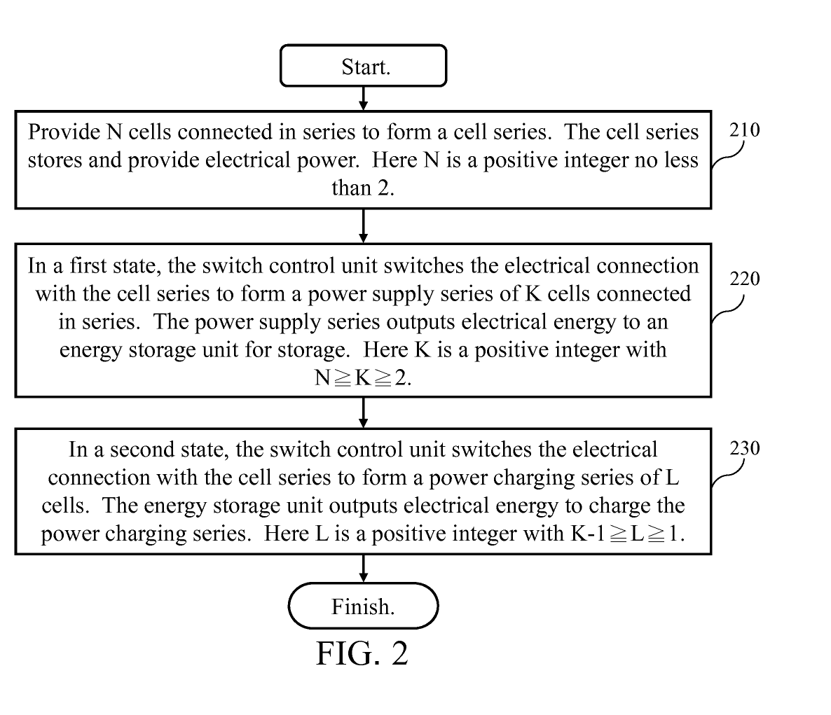

FIG. 2 is a flowchart of the disclosed capacitor active balancing method with high-voltage differential. The method includes the following steps. Step 210 provides N cells 10 connected in series into a cell series 100 for storing and providing electrical power, where N is a positive integer no less than 2. In the first state, the switch control unit 20 switches the electrical connection with the cell series 100 to form a power supply series of K cells 10 connected in series. The power supply series outputs electrical power to the energy storage unit 30 for storage. Here K is a positive integer with N≧K≧2 (step 220). In the second state, the switch control unit 20 switches the electrical connection with the cell series 100 to form the power charging series of L cells 10. The energy storage unit 30 outputs electrical power to the power supply series for charging. Here L is a positive integer with K−1≧L≧1 (step 230). Through the above-mentioned steps, the cells 10 connected in series can charge the energy storage unit 30 under high-voltage differential. The energy storage unit 30 discharges cells 10 with lower electrical power to complete energy transfer and battery balancing.

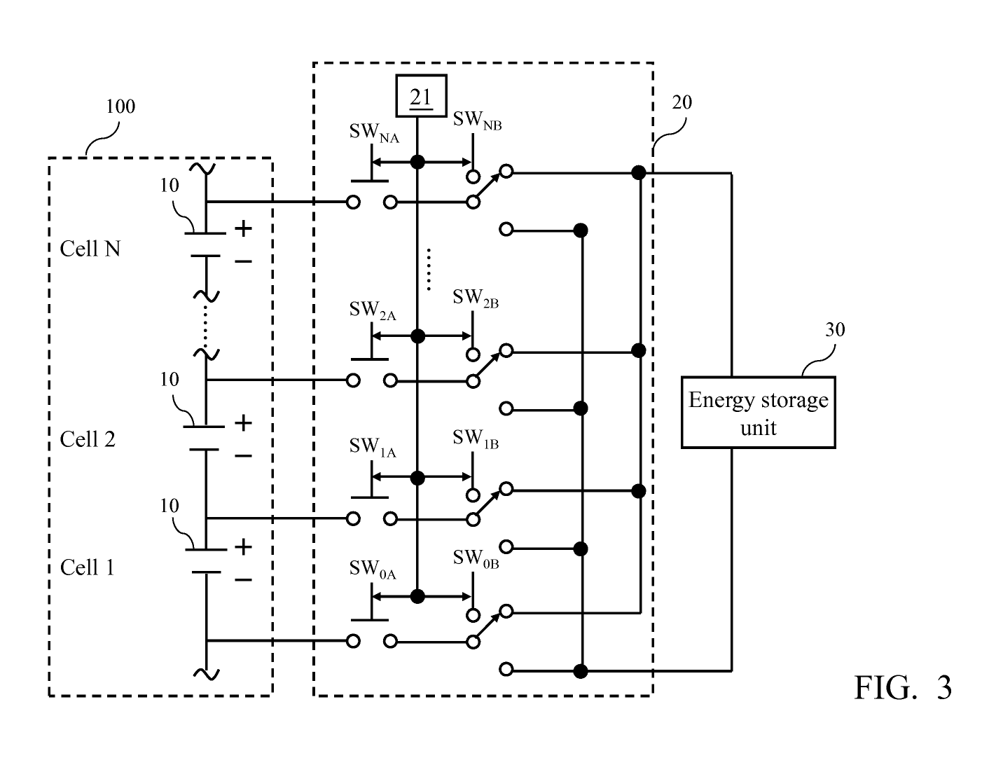

An embodiment is explained with reference to FIGS. 3 to 7B. FIG. 3 is a circuit diagram of the CAN device with high-voltage differential. As mentioned before, the switch control unit 20 can switch between different electrical connections. In practice, the switch control unit 20 consists of many switches, such as SW_{0A}˜SW_{NA} and SW_{0B}˜SW_{NB} and a controller 21 for controlling these switches. The on and off of these switches adjust the electrical connections with the cell series 100 and the energy storage unit 30. Some of the switches are turned on to connect at least one cell 10 in the cell series with the energy storage unit 30 to form a circuit (called the charging/discharging circuit). The following paragraphs explain how the switch control unit 20 forms the power supply series and the power charging series.

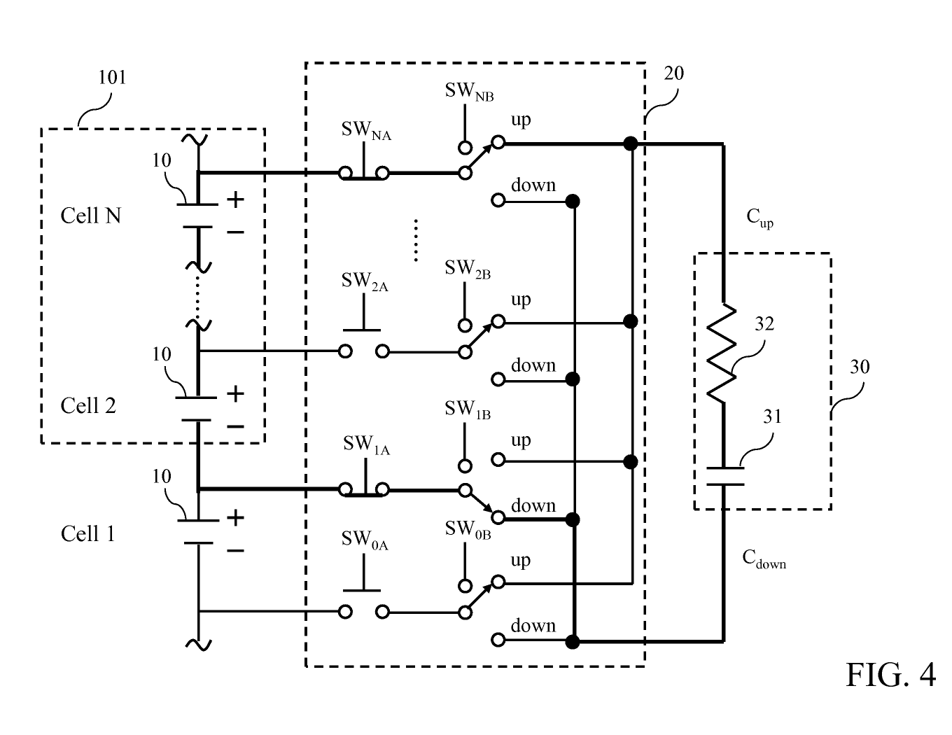

FIG. 4 shows how the circuit of power supply series is formed according to the invention. As explained before, the switch control unit 20 switches the electrical connection in the first state to form the power supply series of K cells connected in series. In FIG. 4, the power supply series 101 consists of several cells 10 (cell 2 to cell N). The switching method is to short the switches SW_{1A} and SW_{NA} and to change switch SW_{1B} to “down” and switch SW_{NB} to “up.” As a result, the power supply series 101 and the energy storage unit 30 form a circuit (shown by the black solid lines). As there is high-voltage differential between the power supply series 101 and the energy storage unit 30, electrical power on the power supply series 101 can be rapidly transferred to the energy storage unit 30. Besides, the capacitor 31 and the resistor 32 connected in series in the energy storage unit 30 form an RC circuit in FIG. 4. The user can thus adjust the resistance of the resistor 32 and the capacitance of the capacitor 31 to change the response time. In practice, the charging time of the energy storage unit 30 is greater than or equal to 0.3 RC. The discharging time for discharging the energy storage unit 30 to the power charging series 102 is also greater than or equal to 0.3 RC.

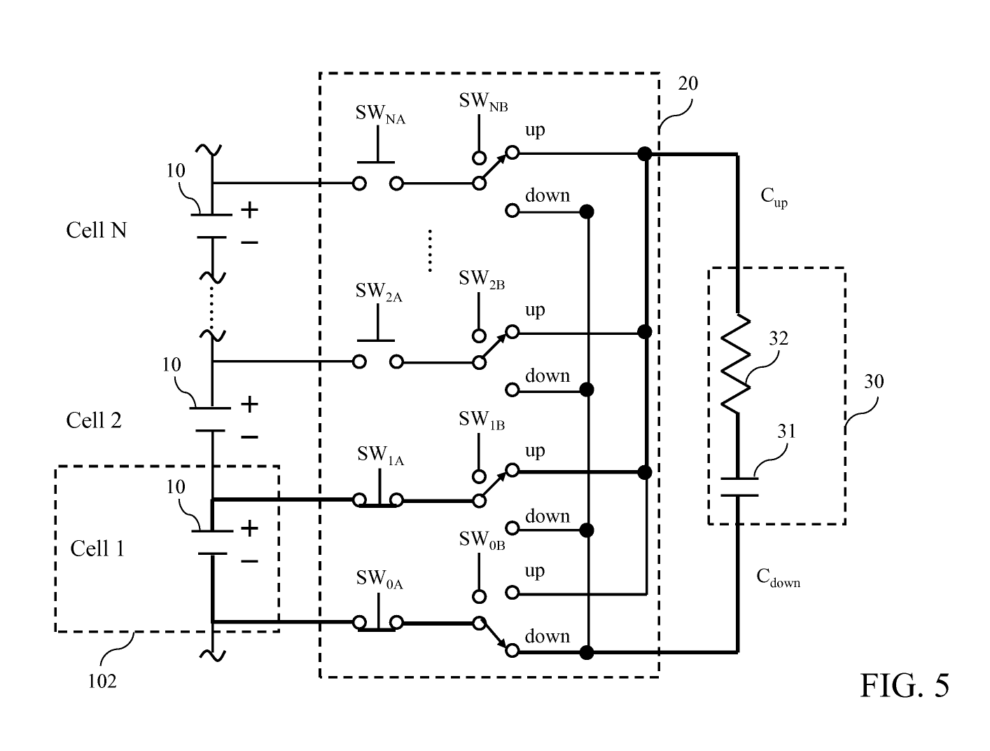

FIG. 5 shows how the power charging series is formed according to the invention. After the energy storage unit 30 completes charging in the first state, it switches to the second state. The switch control unit 20 shorts switch SW_{0A} and switch SW_{1A}, and changes switch SW_{1B} to “up” and switch SW_{0B} to “down.” Consequently, the power charging series 102 is formed to render a circuit with the energy storage unit 30 (shown by the black solid lines). In this case, the energy storage unit 30 charges cells 10 of lower electrical power (i.e., cell 1).

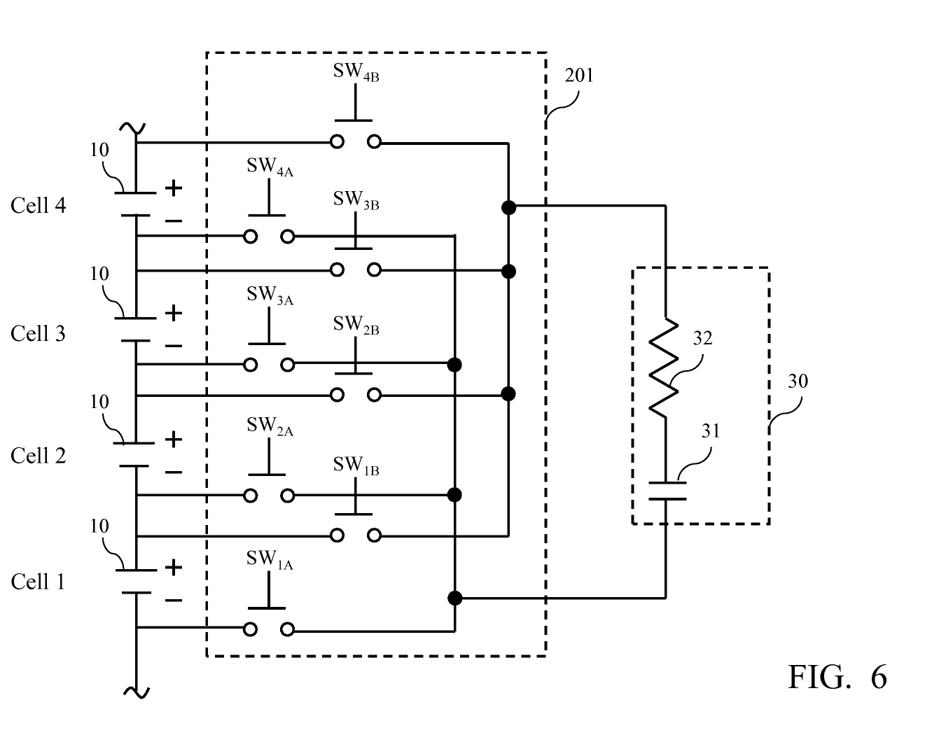

FIG. 6 shows the circuit of the switch control unit in another embodiment of the invention. In practice, one may also form the power supply series 101 and the power charging series 102 using the switch control unit 201 shown in FIG. 6. It should be mentioned that in this embodiment, the switch control unit 201 has multiple switches SW_{NA} and SW_{NB}. When some cells 10 in the cell series 100 form a circuit with the energy storage unit 30 via the switch control unit 201, only one of the switches SW_{NA} is on and only one of the switches SW_{NB} is on as well.

Although an explicit embodiment is used to illustrate the switch control unit 20, 201 with reference to FIGS. 5 and 6, the invention is not limited to such cases. In practice, any means to form a power supply series 101 of K cells 10 connected in series and a power charging series 102 of L cells 10 connected in series from N cells should be included within the scope of the invention. Here N is a positive integer no less than 2, and K and L are positive integers with N≧K≧2 and K−1≧L≧1.

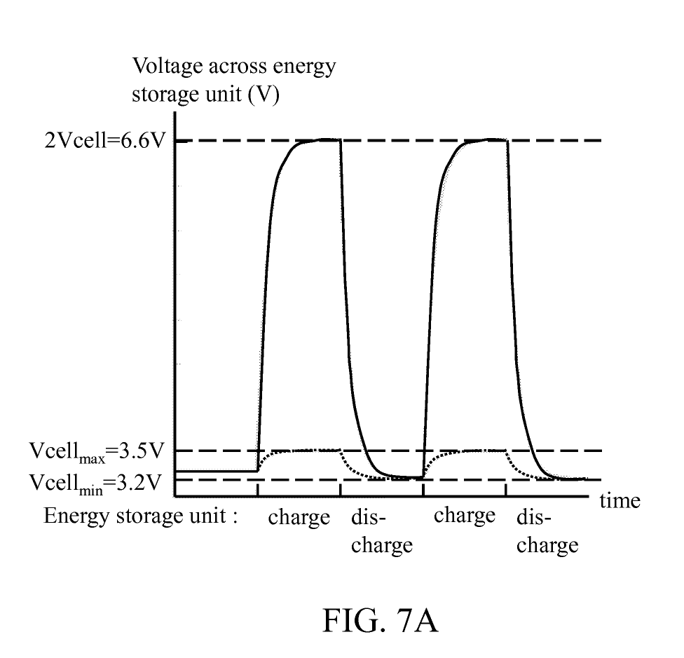

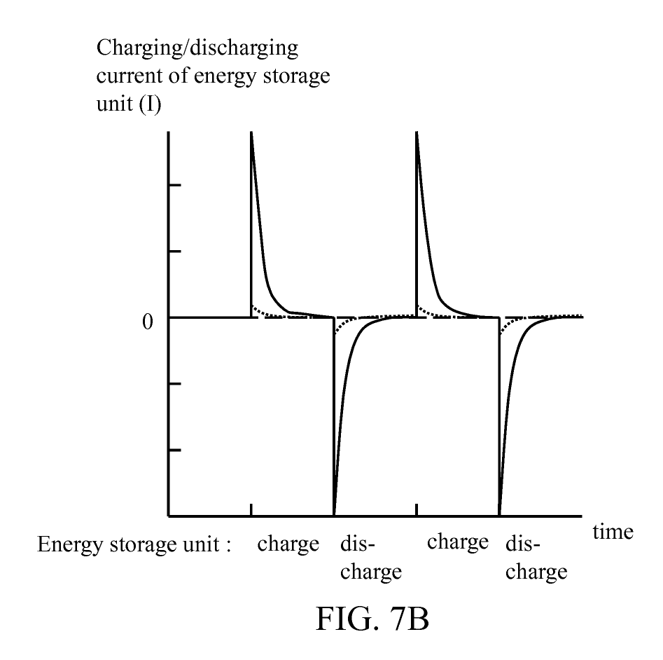

FIGS. 7A and 7B are plots showing the voltages and currents of the invention and conventional capacitor balancing. First, FIG. 7A shows the application in a lithium battery. The solid curve shows the voltage across the disclosed energy storage unit 30. The dotted curve is the voltage across the capacitor in the conventional capacitor balancing. According to FIG. 7A, both voltages are significantly different (larger than a factor of 10). In FIG. 7B, the solid curve shows the charging/discharging current of the energy storage unit 30. The dotted curve shows the charging/discharging current of the capacitor in the conventional capacitor balancing. According to FIG. 7B, it is clear that there is a big difference in the transferred electricity between the invention and the conventional capacitor balancing (larger than a factor of 10M). The transferred electricity is equal to the current integral and is determined by the voltage differential between the energy storage unit 30 and the power supply series 101 or the power charging series 102. It should be explained that M=K−L. When K−L=1, M=1. Therefore, the transferred electricity of the invention is more than 10 times (10*1=10) that of the prior art. When K−L=2, M=2. Thus, the transferred electricity of the invention is more than 20 times (10*2=20) that of the prior art. Moreover, the wave amplitude of the invention is greater than the conventional capacitor balancing. Therefore, the electricity can be more easily quantified and controlled.

In summary, the invention differs from the prior art in that multiple cells 10 are connected in series to charge the energy storage unit 30 under high-voltage differential, and that the energy storage unit 30 discharges cells 10 of lower electrical power, thereby completing energy transfer and battery balancing. This technique can solve problems in the prior art and increase battery balancing efficiency.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A capacitor active balancing device with high-voltage differential, comprising:
N cells connected in series to form a cell series for storing and providing electrical energy, with N being a positive integer no less than 2;
a switch control unit electrically connected to the cell series for in a first state switching the electrical connection with the cell series to form a power supply series of K cells connected in series and in a second state switching the electrical connection with the cell series to form a power charging series of L cells, with K and L being positive integers and N≧K 2, K−1≧L≧1; and
an energy storage unit electrically connecting to the switch control unit for receiving and storing the electrical energy of the power supply series in the first and for outputting the electrical energy of the energy storage unit to charge the power charging series in the second state.

2. The capacitor active balancing device with high-voltage differential of claim 1, wherein the energy storage unit contain at least one capacitor.

3. The capacitor active balancing device with high-voltage differential of claim 2, wherein the at least one capacitor is connected in series with a resistor selected from the group consisting of the capacitor equivalent capacitor, normal resistor, switch resistor, battery internal resistor, and the combination thereof

4. The capacitor active balancing device with high-voltage differential of claim 3, wherein the resistance of the resistor and capacitance of the capacitor are adjusted to change a response time.

5. The capacitor active balancing device with high-voltage differential of claim 1, wherein the switch control unit includes a plurality of switches and a controller for controlling the switches.

6. The capacitor active balancing device with high-voltage differential of claim 5, wherein some of the switches are turned on to connect at least one cell in the cell series and the energy storage unit to form a circuit.

7. A method of capacitor active balancing with high-voltage differential, comprising the steps of:
providing N cells connected in series to form a cell series for storing and providing electrical energy, with N being a positive integer no less than 2;
when a switch control unit is in a first state, switching the electrical connection with the cell series to form a power supply series of K cells connected in series for outputting electrical energy to an energy storage unit for storage, with K a positive integer and N≧K≧2; and
when the switch control unit is in a second state, switching the electrical connection with the cell series to form a power charging series of L cells for outputting electrical energy to and charging the power charging series, with L a positive integer and K−1≧L≧1.

8. The method of capacitor active balancing with high-voltage differential according to claim 7, wherein the energy storage unit includes at least one capacitor.

9. The method of capacitor active balancing with high-voltage differential according to claim 8, wherein the at least one capacitor is connected in series with a resistor selected from the group consisting of the capacitor equivalent capacitor, normal resistor, switch resistor, battery internal resistor, and the combination thereof

10. The method of capacitor active balancing with high-voltage differential according to claim 9, wherein the resistance of the resistor and capacitance of the capacitor are adjusted to change a response time.
